(19) United States
(12) Patent Application Publication
(10) Pub. No.: US 2021/0214250 A1
(43) Pub. Date: Jul. 15, 2021

(54) OZONE WATER GENERATION DEVICE, WATER TREATMENT DEVICE, OZONE WATER GENERATION METHOD, AND CLEANING METHOD

(71) Applicant: Mitsubishi Electric Corporation, Tokyo (JP)

(72) Inventors: Eiji IMAMURA, Tokyo (JP); Nozomu YASUNAGA, Tokyo (JP); Seiji NODA, Tokyo (JP)

(73) Assignee: Mitsubishi Electric Corporation, Tokyo (JP)

(21) Appl. No.: 17/056,020

(22) PCT Filed: Jun. 13, 2018
(86) PCT No.: PCT/JP2018/022549

§ 371 Date: Nov. 17, 2020

(51) Int. Cl. C02F 1/78; C02F 1/36

(52) U.S. Cl. CPC C02F 1/78; C02F 1/36; C02F 2209/003; C02F 2209/06; C02F 2209/04; C02F 2209/22; C02F 2209/001; C02F 2305/02

(57) ABSTRACT

A water treatment device includes: an oxidationor for causing pretreatment gas to be in contact with filtered water; a water quality measurement device for performing water quality measurement for the filtered water; and a controller which controls the oxidationor, determines oxidation progress of oxidizable substances in the filtered water on the basis of a first change amount obtained from change over time in a measurement value obtained through water quality measurement for the filtered water by the water quality measurement device, and determines to continue or stop supply of the pretreatment gas to the filtered water.

### TECHNICAL FIELD

The present disclosure relates to an oxidation device for performing treatment on oxidizable substances in treatment target water, a water treatment device including the oxidation device, a water treatment method using the oxidation device, an ozone water generation method for generating ozone water on the basis of treatment target water treated by the water treatment method, and a cleaning method using the ozone water.

### BACKGROUND ART

In water cleaning treatment, waste water treatment, and the like, water treatment technology using ozone is widely applied. This water treatment technology is also used, for example, in the case of decomposing impurities such as organic substances contained in waste water by directly supplying ozone gas to waste water to be treated, or in the case of generating ozone water as a cleaning agent for a filtration membrane to which impurities are adhered in membrane separation technology for filtering impurities in waste water by the filtration membrane to obtain clean water (see, for example, Patent Document 1).

Both of the above cases are equal in using ozone (dissolved ozone) dissolved in water for decomposing organic substances in waste water or organic substances adhered to a filtration membrane, and thus it is important to stably keep the dissolved ozone present in water.

However, ozone can react with substances other than organic substances to be removed, and thus can be consumed. In particular, ozone readily reacts with oxidizable inorganic substances such as iron, manganese, and nitrous acid, and these substances act as inhibitors against the purpose of stably ensuring the dissolved ozone concentration. Therefore, in order to prevent ozone from being consumed through reaction between ozone and oxidizable inorganic substances in water, disclosed is technology of blowing air into water before supplying ozone to the water, so as to aerate the water, thereby oxidizing and removing oxidizable substances (see, for example, Patent Document 2).

### CITATION LIST

### Patent Document

Patent Document 1: Japanese Laid-Open Patent Publication No. 2004-105876 (paragraphs [0008] to [0012], FIG. 4) (paragraph [0067])

Patent Document 2: Japanese Laid-Open Patent Publication No. 11-253940

### SUMMARY OF THE INVENTION

### Problems to be Solved by the Invention

In the above conventional water treatment technology, in the case of using water such as underground water that has comparatively stable water quality so that variation in the oxidizable substance concentration is small, an oxidizable substance removing effect is obtained to a certain extent even if air is redundantly supplied. However, in the case of using water such as sewage water or industrial waste water that has unstable water quality so that variation in the oxidizable substance concentration is great, excess/deficiency of air supply can occur.

In the case where air is deficient, supplied ozone is consumed by oxidizable substances remaining in water, and therefore the dissolved ozone concentration cannot be increased. In this case, there is a problem that organic substances remain in discharged water or the cleaning effect of generated ozone water is reduced.

Meanwhile, in the case of supplying air to water more than necessary, there is a problem that an excess amount of carbonate ions is dissolved in the water. In particular, in the case of cleaning a filtration membrane by using ozone water, in order to enhance the cleaning effect, it is necessary that hydroxyl radicals (OH radicals) which are generated through self-decomposition of ozone and are lower in reactivity with organic substances than ozone, are contained at a high concentration in ozone water. It is known that a carbonate ion acts as a radical scavenger, and excess air supply can reduce the filtration membrane cleaning effect of the ozone water.

From the above, technology that enables oxidizable substances to be sufficiently removed from water without supplying excess air to water, is required.

The present disclosure has been made to solve the above problem, and an object of the present disclosure is to provide an oxidation device capable of supplying, without excess/deficiency, an oxidation material containing an oxidizing substance to treatment target water, and a water treatment device including the oxidation device, provide a water treatment method using the oxidation device, provide an ozone water generation method for generating ozone water having a high cleaning effect on the basis of treatment target water treated by the water treatment method, and provide a cleaning method using the ozone water.

### Solution to the Problems

An oxidation device according to the present disclosure is an oxidation device for oxidizing oxidizable substances contained in treatment target water by causing an oxidation material containing an oxidizing substance to be in contact with the treatment target water, the oxidation device including: an oxidation unit for causing the oxidation material to be in contact with the treatment target water; a measurement unit for performing water quality measurement for the treatment target water; and a control unit which controls the oxidation unit, determines oxidation progress of the oxidizable substances in the treatment target water on the basis of a first change amount obtained from change over time in a measurement value obtained through water quality measurement for the treatment target water by the measurement unit, and determines to continue or stop supply of the oxidation material to the treatment target water.

A water treatment device according to the present disclosure includes: the oxidation device configured as described above; a filtration unit for filtering organic substances in raw water to generate filtered water; a first transfer unit for transferring the filtered water as the treatment target water to the oxidation unit; an ozone water generation unit for generating ozone water by supplying ozone gas to the treatment target water for which supply of the oxidation material has been determined to be stopped; and a second transfer unit for transferring the ozone water to the filtration unit.

A water treatment method according to the present disclosure is a water treatment method for oxidizing oxidizable substances contained in treatment target water by causing an oxidation material containing an oxidizing substance to be in contact with the treatment target water, the water treatment method including: determining oxidation progress of the oxidizable substances in the treatment target water on the basis of a first change amount obtained from change over time in a measurement value obtained through water quality measurement for the treatment target water, and determining to continue or stop supply of the oxidation material to the treatment target water.

An ozone water generation method according to the present disclosure includes generating ozone water by supplying ozone gas to the treatment target water for which supply of the oxidation material has been determined to be stopped in the water treatment method configured as described above.

A cleaning method according to the present disclosure includes cleaning a cleaning target part using the ozone water generated by the ozone water generation method configured as described above.

### Effect of the Invention

In the oxidation device and the water treatment method according to the present disclosure, an oxidation material containing an oxidizing substance can be supplied without excess/deficiency, to treatment target water, whereby it is possible to obtain treatment target water in which dissolution of carbonate ions is reduced and oxidizable substances are sufficiently removed.

The water treatment device according to the present disclosure includes the oxidation device configured as described above, and the ozone water generation unit for generating ozone water on the basis of treatment target water treated by the oxidation device. Therefore, the filtration unit can be cleaned using ozone water having a high cleaning effect.

In the ozone water generation method according to the present disclosure, ozone water is generated on the basis of treatment target water in which dissolution of carbonate ions is reduced and oxidizable substances are sufficiently removed, whereby ozone water having a high cleaning effect can be obtained.

In the cleaning method according to the present disclosure, a cleaning target part is cleaned using ozone water having a high cleaning effect. Therefore, an effect of removing dirt in the cleaning target part can be improved.

### BRIEF DESCRIPTION OF THE DRAWINGS

FIG. 1 is a block diagram showing the schematic configuration of an oxidation device and a water treatment device according to embodiment 1.

FIG. 2 is a flowchart showing a treatment method for treatment target water in the oxidation device according to embodiment 1.

FIG. 3 is a result of water quality measurement for treatment target water obtained by the oxidation device according to embodiment 1.

FIG. 4 is a flowchart showing a treatment method for treatment target water in the oxidation device according to embodiment 1.

FIG. 5 is a result of water quality measurement for treatment target water obtained by the oxidation device according to embodiment 1.

FIG. 6 is a flowchart showing a treatment method for treatment target water in the oxidation device according to embodiment 1.

FIG. 7 is a result of water quality measurement for treatment target water obtained by the oxidation device according to embodiment 1.

FIG. 8 is a result of water quality measurement for treatment target water obtained by the oxidation device according to embodiment 1.

FIG. 9 is a block diagram showing the schematic configuration of a water treatment device according to embodiment 2.

FIG. 10 is a diagram showing the schematic configuration of an outside air contact device according to embodiment 2.

FIG. 11 is a block diagram showing the schematic configuration of an oxidation device and a water treatment device according to embodiment 3.

FIG. 12 is a flowchart showing a treatment method for treatment target water in the oxidation device according to embodiment 3.

FIG. 13 is a flowchart showing a treatment method for treatment target water in the oxidation device according to embodiment 3.

FIG. 14 is a block diagram showing the schematic configuration of a water treatment device according to embodiment 4.

FIG. 15 is a flowchart showing a treatment method for treatment target water in the water treatment device according to embodiment 4.

### DESCRIPTION OF EMBODIMENTS

### Embodiment 1

Hereinafter, an oxidation device, a water treatment device, a water treatment method, an ozone water generation method, and a cleaning method according to the present embodiment 1 will be described with reference to the drawings.

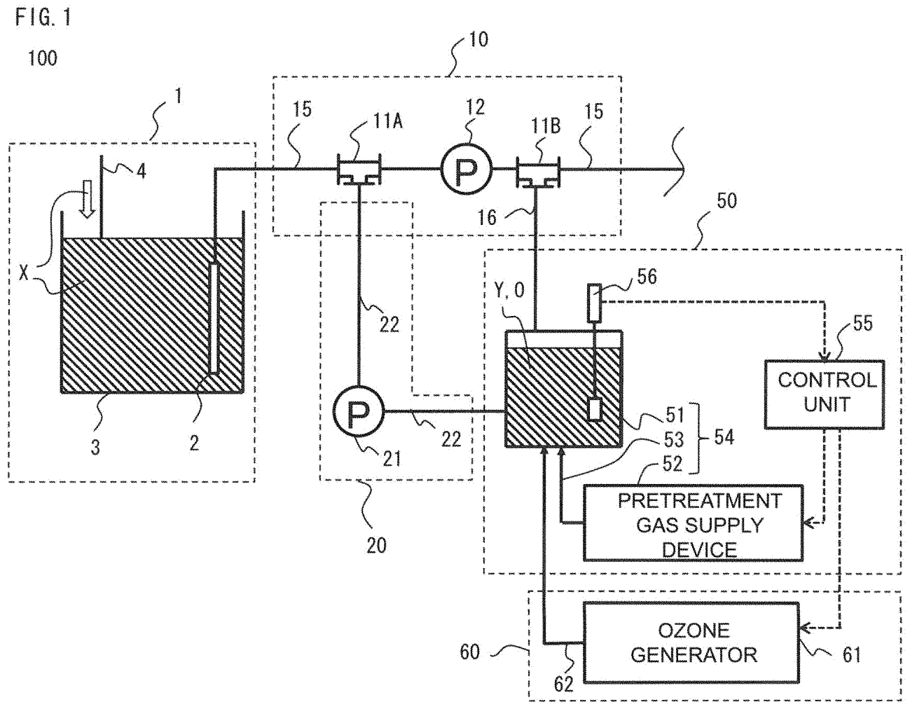

FIG. 1 is a diagram showing the schematic configuration of a water treatment device 100 including an oxidation device 50 according to embodiment 1.

As shown in FIG. 1, the water treatment device 100 according to the present embodiment includes: a filtration unit 1 for filtering organic substances and the like in raw water X which is a filtration target, to generate filtered water; a first transfer unit 10 for transferring filtered water Y obtained by the filtration unit 1, as treatment target water, to the oxidation device 50 at the subsequent stage; the oxidation device 50 for oxidizing oxidizable substances such as iron, manganese, and nitrous acid contained in the filtered water Y; an ozone water generation unit 60 for supplying ozone gas to the filtered water Y to generate ozone water O; and a second transfer unit 20 for transferring the generated ozone water O to the filtration unit 1.

The filtration unit 1 includes a filtration membrane 2 for filtering the raw water X, a filtration water tank 3 storing the filtration membrane 2, and a raw water pipe 4 for supplying the raw water X to the filtration water tank 3. The raw water X is stored in the filtration water tank 3, and the filtration membrane 2 is immersed in the raw water X. Here, the raw water X is not particularly limited, and may be, for example, natural water taken from a river, a lake, the sea, or the like, or may be waste water such as sewage or industrial waste water.

The first transfer unit 10 includes a filtration pipe 15 connected to the filtration membrane 2, switch valves 11A, 11B provided to the filtration pipe 15, and a filtration pump 12. In addition to the filtration pipe 15, a cleaning water pipe 22 is connected to the switch valve 11A. In addition to the filtration pipe 15, a cleaning water pipe 16 is connected to the switch valve 11B. Further, the cleaning water pipe 16 is connected to the oxidation device 50. It is noted that the flow path of the filtered water Y can be changed through operations of the switch valve 11A and the switch valve 11B, and this will be described later.

By driving the filtration pump 12 of the first transfer unit 10, the filtered water Y is sucked from the filtration unit 1. The sucked filtered water Y as treatment target water is transferred to the oxidation device 50 via the switch valve 11A and the switch valve 11B.

The oxidation device 50 includes an oxidation unit 54 for causing pretreatment gas P as an oxidation material containing an oxidizing substance such as oxygen to be in contact with the filtered water Y, a control unit 55 for controlling the oxidation unit 54, and a water quality measurement device 56 as a measurement unit for performing water quality measurement for the filtered water Y.

As the water quality measurement device 56, for example, any one of a pH meter, a dissolved oxygen concentration (DO) meter, or a standard oxidation reduction potential (ORP) meter is used or some of them are used in combination.

The oxidation unit 54 includes a treatment water tank 51 for storing the filtered water Y transferred by the first transfer unit 10, a pretreatment gas supply device 52 for sending pretreatment gas P, and a pretreatment gas supply pipe 53 for jetting the pretreatment gas P sent from the pretreatment gas supply device 52, into the filtered water Y stored in the treatment water tank 51. The control unit 55 receives a water quality measurement result obtained by the water quality measurement device 56, and performs calculation described later on the basis of the result, to perform output control for the pretreatment gas P.

It is noted that the control unit 55 may be any device, such as a programmable logic controller (PLC), a C language controller, or a general-purpose personal computer, that can receive a signal from the water quality measurement device 56 and perform a predetermined calculation described later on the basis thereof. Alternatively, for example, an operation manager acting as the control unit may perform operation in accordance with a predetermined calculation described later.

The ozone water generation unit 60 includes an ozone generator 61 for generating ozone gas, and an ozone gas supply pipe 62 for supplying the generated ozone gas into the filtered water Y stored in the treatment water tank 51. When the ozone gas is supplied into the filtered water Y, ozone is dissolved into the filtered water Y. Hereinafter, the filtered water Y having ozone dissolved therein is referred to as ozone water O.

The second transfer unit 20 includes a transfer pump 21 and the cleaning water pipe 22 provided so that ozone water O is sucked from a lower part of the treatment water tank 51 via the transfer pump 21. The cleaning water pipe 22 is connected to the switch valve 11A and is configured to be able to transfer the ozone water O to the filtration unit 1 via the filtration pipe 15 by the switch valve 11A being operated to change the flow path.

Next, a series of operations of the water treatment device 100 including the oxidation device 50 according to the present embodiment 1 configured as described above, will be described.

The series of operation processes performed by the water treatment device 100 include a membrane filtration process, a pretreatment process, an ozone water generation process, and a cleaning process. Through these processes, the water treatment device 100 filters waste water or the like by the filtration membrane, removes oxidizable inorganic substances such as iron from a part of the filtered water, generates ozone water on the basis of the filtered water from which oxidizable inorganic substances have been removed, and cleans the filtration membrane by the generated ozone water.

First, the membrane filtration process will be described.

In the membrane filtration process, in the filtration unit 1, raw water X is fed to the filtration water tank 3, the raw water X is filtered by the filtration membrane 2, and the filtered water is transferred by the first transfer unit 10.

The raw water X such as waste water supplied from the raw water pipe 4 is stored in the filtration water tank 3 once, and then the filtration pump 12 is driven so that the raw water X flows from the primary side to the secondary side of the filtration membrane 2 and thus is filtered. The filtered water Y obtained through the filtration is discharged to a treatment facility (not shown) at the subsequent stage through the filtration pipe 15 by the first transfer unit 10, or in the case where the water level of the treatment water tank 51 in the oxidation device 50 is not at a predetermined position, the filtered water Y is transferred to the treatment water tank 51 by operation of the switch valve 11B.

In the case of performing treatment using activated sludge mainly containing microorganisms in the filtration unit 1 (in the case of operating as a membrane bioreactor), activated sludge may be stored in the filtration water tank 3 and the raw water X may be introduced there. In addition, filtration may be performed continuously or intermittently. In addition, even if reverse cleaning is performed to cause the filtered water Y to flow as cleaning water from the secondary side to the primary side of the filtration membrane 2 at an interval during filtration, this does not prevent the effects of the present invention from being obtained.

Next, the pretreatment process will be described.

In the pretreatment process, in the oxidation device 50, a pretreatment gas supply step and a water quality confirmation step are performed at the same time or alternately, whereby the pretreatment gas P is supplied in accordance with oxidation progress of oxidizable inorganic substances contained in the filtered water Y, to remove oxidizable inorganic substances in the filtered water Y. Thus, oxidizable substances which hamper generation of ozone water in the ozone water generation process described later can be removed by the pretreatment gas P.

In the pretreatment gas supply step performed in the pretreatment process, the pretreatment gas P is supplied from the pretreatment gas supply device 52 through the pretreatment gas supply pipe 53 to the filtered water Y stored in the treatment water tank 51. Thus, the oxidizing substance contained in the pretreatment gas P and oxidizable substances in the filtered water Y react with each other, whereby the oxidizable substances are oxidized.

As the pretreatment gas P, for example, gas containing an oxidizing substance, such as air, oxygen gas, or mixture gas of nitrogen and oxygen, can be used. Therefore, as the pretreatment gas supply device 52, for example, a blower, a cylinder filled with oxygen gas, a gas cylinder filled with mixture gas of oxygen and nitrogen, an oxygen gas generation device, or the like can be used.

In addition, in the water quality confirmation step performed in the pretreatment process, the control unit 55 determines oxidation progress of oxidizable substances in the filtered water Y on the basis of a result of water quality measurement for the filtered water Y obtained through water quality measurement by the water quality measurement device 56, and on the basis of this determination result, determines to continue or stop supply of the pretreatment gas P to the filtered water Y.

That is, in the case where the control unit 55 has determined that oxidation of oxidizable substances in the filtered water Y is all completed, the control unit 55 determines to stop supply of the pretreatment gas P from the pretreatment gas supply device 52 and thus finishes the pretreatment process. In the case where the control unit 55 has determined that oxidation of oxidizable substances in the filtered water Y is not completed, the control unit 55 determines to continue supply of the pretreatment gas P from the pretreatment gas supply device 52. The details of processing for performing this determination by the control unit 55 will be described later.

Next, the ozone water generation process will be described.

In the ozone water generation process, generation of ozone water O is performed after the pretreatment process is completed. That is, the ozone generator 61 starts to generate ozone gas, and the generated ozone gas is supplied through the ozone gas supply pipe 62 into the filtered water Y in the treatment water tank 51. The ozone gas is supplied into the filtered water Y during a predetermined period, and when the ozone concentration in the filtered water Y has reached a target concentration, supply of the ozone gas is stopped and thus the ozone water generation process is completed.

As an ozone gas supply method, for example, the ozone gas may be supplied from a lower part of the treatment water tank 51 by using an air diffuser formed from ceramic, fluororesin, stainless steel, or the like, or may be supplied while the filtered water Y and the ozone gas are mixed by an ejector or the like.

Next, the cleaning process will be described.

In the cleaning process, in the case where the filtration performance of the filtration membrane 2 is considered to be reduced in the membrane filtration process, the membrane filtration process is stopped and cleaning of the filtration membrane 2 by ozone water O is started. That is, the switch valve 11A is operated to switch the flow path so that the ozone water O in the treatment water tank 51 flows from the cleaning water pipe 22 to the filtration pipe 15. Then, the transfer pump 21 is driven to transfer the ozone water O in the treatment water tank 51 to the filtration membrane 2 so that the ozone water O flows from the secondary side to the primary side of the filtration membrane 2. In this way, by performing reverse cleaning so that the ozone water O flows from the secondary side to the primary side of the filtration membrane 2, clogging of the filtration membrane is eliminated and organic substances adhered to the filtration membrane are decomposed by ozone so as to be removed.

After the cleaning process is completed, the membrane filtration process is restarted.

Thus, the membrane filtration process, the pretreatment process, the ozone water generation process, and the cleaning process which are a series of operations of the filtration device 100, have been described.

Next, the reason why the control unit 55 performs the pretreatment gas supply step and the water quality confirmation step at the same time or alternately to supply the pretreatment gas P in accordance with oxidation progress of oxidizable substances in the filtered water Y in the above pretreatment process, and the details of this process, will be described.

The water quality of the filtered water Y, i.e., the concentration of oxidizable substances contained in the filtered water Y is not always constant, but greatly varies in accordance with mainly the water quality of the filtered water Y. Therefore, if the supply amount of the pretreatment gas P to the filtered water Y is fixed, oxidizable substances are not sufficiently removed or the pretreatment gas P is excessively supplied, leading to inefficiency. That is, by supplying necessary and sufficient pretreatment gas P while recognizing the oxidation completion point of oxidizable substances in the filtered water Y at each time, it is possible to avoid ineffective consumption of ozone during generation of ozone water O so as to efficiently generate ozone water O, and also keep the cleaning performance of ozone water O stably at high level.

Through earnest studies, it has been found that the oxidation completion point of oxidizable substances in the filtered water Y can be confirmed by water quality measurement for the filtered water Y. That is, in the pretreatment process, as described below, by performing the “pretreatment gas supply step” and the “water quality confirmation step” at the same time or alternately, it becomes possible to oxidize oxidizable substances contained in the filtered water Y by the pretreatment gas P without excess/deficiency.

In the water quality confirmation step, as described above, the control unit 55 determines oxidation progress of oxidizable substances in the filtered water Y on the basis of a result of water quality measurement for the filtered water Y. That is, the control unit 55 calculates a water quality change amount as a first change amount in a predetermined period, which is obtained from change over time in the water quality measurement value, and determines oxidation progress of oxidizable substances on the basis of the water quality change amount.

As described above, as the water quality measurement device 56, any one of a pH meter, a dissolved oxygen concentration (DO) meter, or a standard oxidation reduction potential (ORP) meter is used or some of them is used in combination. Then, the control unit 55 performs the above determination on the basis of the water quality change amount obtained from change over time in the pH value, the dissolved oxygen concentration (DO) value, or the standard oxidation reduction potential (ORP) value.

Hereinafter, the pretreatment process of the control unit 55 will be described, assuming that the DO meter or the ORP meter is provided as the water quality measurement device 56, and the pretreatment gas supply step and the water quality confirmation step are performed at the same time, i.e., while the pretreatment gas P is always supplied to the filtered water Y, water quality confirmation for the filtered water Y is performed.

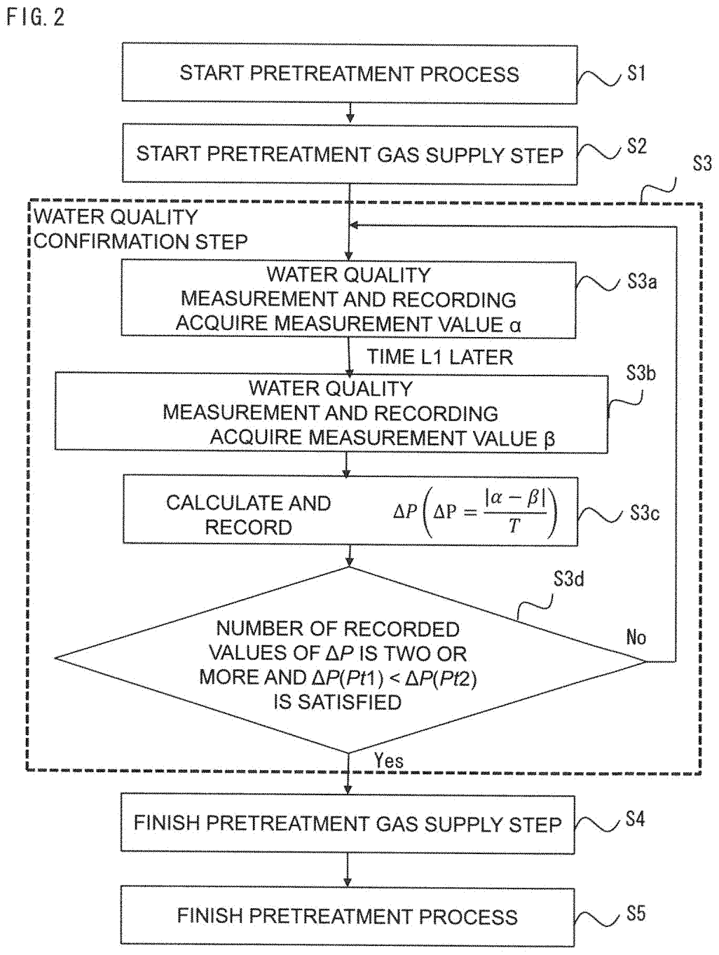

FIG. 2 is a flowchart showing the treatment method in the case where the control unit 55 performs the pretreatment process on the basis of at least one of the DO value or the ORP value measured while the pretreatment gas P is always being supplied, according to embodiment 1.

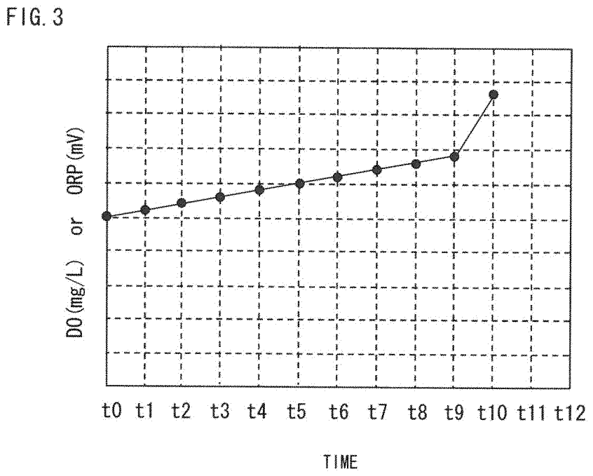

FIG. 3 is a graph showing change over time in the DO value or the ORP value obtained by the water quality measurement device 56 measuring the filtered water Y while the pretreatment gas P is being supplied, according to embodiment 1.

When the pretreatment process is started (step S1), first, the control unit 55 starts the pretreatment gas supply step to supply the pretreatment gas P into the filtered water Y (step S2).

Next, the control unit 55 starts the water quality confirmation step for determining oxidation progress of oxidizable substances in the filtered water Y (step S3).

In the water quality confirmation step (step S3), the control unit 55 performs water quality measurement for at least one of the DO value or the ORP value of the filtered water Y by the water quality measurement device 56, and records the measurement value thereof (step S3a).

Next, the control unit 55 performs water quality measurement again after elapse of a time L1, and records the measurement value thereof again (step S3b).

Next, using the measurement values obtained in step S3a and step S3b as a first measurement value α and a second measurement value β, respectively, the control unit 55 calculates the first change amount obtained from change over time in the measurement value, i.e., an absolute value ΔP of the slope of a line connecting the measurement value α and the measurement value β, in accordance with the following Expression (1), and records the calculated value (step S3c).

ΔP=|α−β|/T Expression (1)

Next, if the number of recorded values of ΔP is less than two (step S3d, No), the control unit 55 returns to step 3a to newly acquire the first measurement value α and the second measurement value β, calculate the absolute value ΔP of the slope therebetween, and record the calculated value. Thus, when the number of recorded values of ΔP has become two or more, the control unit 55 compares the magnitudes of a first slope Pt1 and a second slope Pt2, using the previously acquired absolute value ΔP of the slope as the first slope Pt1, and the newly acquired absolute value ΔP of the slope as the second slope Pt2.

As a result of the comparison, if the second slope Pt2 is greater than the first slope Pt1 (step S3d, Yes), the control unit 55 determines that oxidation of oxidizable substances in the filtered water Y is completed, and determines to stop supply of the pretreatment gas P to the filtered water Y. In this case, after completing the water quality confirmation step S3, the control unit 55 completes the pretreatment gas supply step, to stop supply of the pretreatment gas P (step S4), and thus finishes the pretreatment process (step S5).

It is noted that, as a result of the comparison, if the second slope Pt2 is equal to or smaller than the first slope Pt1 (step S3d, No), the control unit 55 returns to step S3a to continue the water quality confirmation step.

It is noted that the above time L1 is favorably 10 to 600 seconds.

Hereinafter, the reason why oxidation progress of oxidizable substances in the filtered water Y can be determined by the processing in the water quality confirmation step S3 shown in FIG. 2, will be described.

As shown in FIG. 3, in the case where the pretreatment gas P containing oxygen continues to be supplied to the filtered water Y so that oxidizable substances in the filtered water Y continue to be oxidized, even though the pretreatment gas P continues to be supplied, the oxidizing substance contained in the pretreatment gas P is consumed by oxidizable substances, whereby the DO value or the ORP value in the filtered water Y is prevented from sharply increasing. The period from t0 to t9 shown in FIG. 3 is a period during which oxidizable substances remain in the filtered water Y, and it is found that the DO value or the ORP value increases at a gradual and almost constant slope even while the pretreatment gas P is being supplied.

On the other hand, when oxidation of oxidizable substances is completed, the increase speed of the DO value or the ORP value becomes great. The period from t9 to t10 shown in FIG. 3 is a period in which oxidation of oxidizable substances has been completed, and it is found that the DO value or the ORP value sharply increases as the pretreatment gas P is supplied.

Therefore, as described above, by calculating the change amount of the DO value or the ORP value obtained from change over time in the water quality measurement value, continuously comparing this, and detecting increase in the increase speed of the measurement value, it becomes possible to determine oxidation progress of oxidizable substances and find the oxidation completion point.

As described above, in the case where there are characteristics in which the slope of the measurement value changes between before and after completion of oxidation of oxidizable substances, it is possible to accurately find the oxidation completion point of oxidizable substances by performing determination using the slope of the measurement value as the first change amount of the measurement value.

In the present embodiment, when a magnitude relationship is compared between a first slope ΔPt1 which is the absolute value of the slope of a line connecting a first measurement value and a second measurement value respectively measured at a first time point t7 and a second time point t8 in FIG. 3, and a second slope ΔPt2 which is the absolute value of the slope of a line connecting a third measurement value and a fourth measurement value respectively measured at a first time point t9 and a second time point t10, it is determined that oxidation of oxidizable substances is completed, and thus supply of the pretreatment gas P is stopped.

In the above water quality confirmation step S3 (S3a, S3b, S3c, S3d), the example in which the control unit 55 calculates the first slope Pt1 and the second slope Pt2 on the basis of at least four measurement values obtained at four time points (e.g., t7, t8, t9, t10), has been shown. However, without limitation thereto, the control unit 55 may calculate the first slope Pt1 and the second slope Pt2 on the basis of at least three measurement values obtained at three time points (e.g., t8, t9, t10). In this case, the slope of a line connecting the first measurement value at the first time point t8 and the second measurement value at the second time point t9 is used as the first slope Pt1, and the slope of a line connecting the second measurement value at the second time point t9 and the third measurement value at the third time point t10 is used as the second slope Pt2, to perform the above determination.

In the above water quality confirmation step S3, whether or not the second slope Pt2 is greater than the first slope Pt1 (first slope Pt1<second slope Pt2) is determined in the oxidation progress determination step S3d. However, without limitation to this determination method, for example, whether or not a value obtained by dividing the second slope Pt2 by the first slope Pt1 is equal to or greater than a predetermined first value R1 ((second slope Pt2/first slope Pt1)≥R1) may be determined. In this case, if, for example, a predetermined value greater than 1 is set as the first value R1, a margin can be provided for the determination, whereby the pretreatment process is prevented from being unintentionally stopped due to error of the measurement value or the like, and thus operation of the pretreatment process can be stabilized.

Thus, the operation in the case of performing the pretreatment process on the basis of at least one of the DO value or the ORP value measured while the pretreatment gas P is always being supplied, has been described.

Hereinafter, operation in the case of providing a pH meter as the water quality measurement device 56 and performing the pretreatment process on the basis of a pH value measured while the pretreatment gas P is always being supplied, will be described.

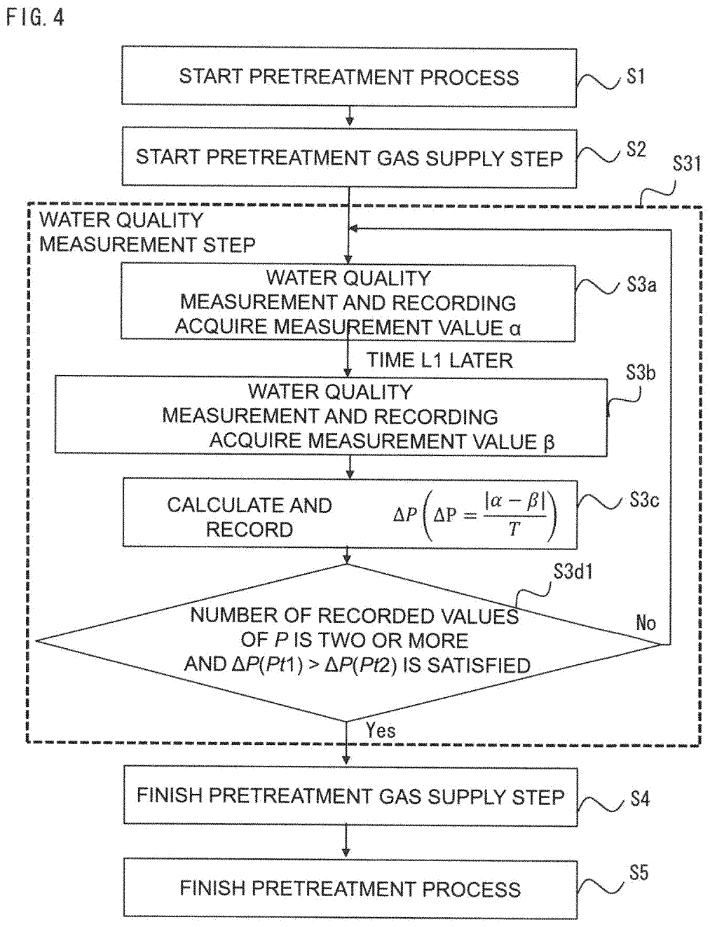

FIG. 4 is a flowchart showing the treatment method in the case where the control unit 55 performs the pretreatment process on the basis of the pH value measured while the pretreatment gas P is always being supplied, according to embodiment 1.

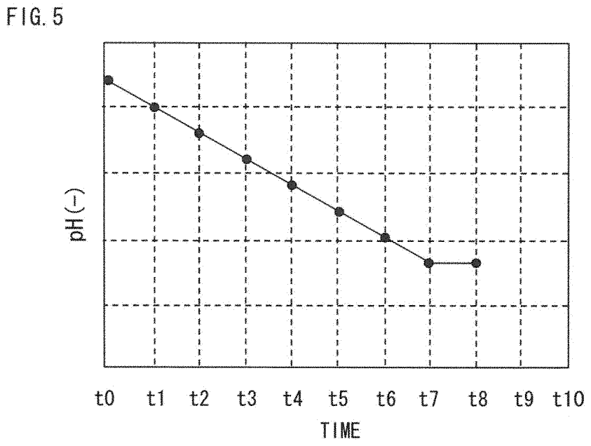

FIG. 5 is a graph showing change over time in the pH value obtained by the water quality measurement device 56 measuring the filtered water Y while the pretreatment gas P is being supplied, according to embodiment 1.

As shown in FIG. 4, in the case of measuring the pH value, only the oxidation progress determination step (step S3d1) in the water quality confirmation step (step S31) is different. The other steps are the same as those in FIG. 2, and description thereof is omitted.

In the case of using a pH meter as the water quality measurement device, as shown in the oxidation progress determination step S3d1 in FIG. 4, as a result of comparison of the slope ΔP, if the second slope Pt2 which is the newly acquired absolute value of the slope is smaller than the first slope Pt1 which is the previously acquired absolute value of the slope (step S3d1, Yes), the control unit 55 determines that oxidation of oxidizable substances in the filtered water Y is completed, and determines to stop supply of the pretreatment gas P to the filtered water Y. In this case, after completing the water quality confirmation step, the control unit 55 completes the pretreatment gas supply step, to stop supply of the pretreatment gas P (step S4), and thus finishes the pretreatment process (step S5).

Hereinafter, the reason why oxidation progress of oxidizable substances in the filtered water Y can be determined by the processing in the water quality confirmation step shown in FIG. 4, will be described.

As shown in FIG. 5, in the case where the pretreatment gas P containing oxygen continues to be supplied to the filtered water Y, for example, when oxidizable substances such as ferrous ions are contained in the filtered water Y, these substances continue to be oxidized so that hydroxide ions continue to be consumed through formation of iron hydroxide, and thus reduction in pH is recognized. The period from t0 to t7 shown in FIG. 5 is a period during which oxidizable substances remain in the filtered water Y, and it is found that the pH value reduces with an almost constant slope.

On the other hand, when oxidation of oxidizable substances is completed, formation of hydroxide is stopped, so that reduction of the pH value becomes gradual. The period from t7 to t8 shown in FIG. 5 is a period in which oxidation of oxidizable substances is completed, and it is found that reduction in the pH value has become gradual.

Therefore, as described above, by calculating the change amount of the pH value obtained from change over time in the water quality measurement value, continuously comparing this, and detecting decrease in the reduction speed of the pH value, it becomes possible to determine oxidation progress of oxidizable substances and find the oxidation completion point.

As described above, in the case where there are characteristics in which the slope of the measurement value changes between before and after completion of oxidation of oxidizable substances, it is possible to accurately find the oxidation completion point of oxidizable substances by performing determination using the slope of the measurement value as the change amount of the measurement value.

In the present embodiment, when a magnitude relationship is compared between a first slope ΔPt1 which is the absolute value of the slope of a line connecting a first measurement value and a second measurement value respectively measured at a first time point t5 and a second time point t6 in FIG. 5, and a second slope ΔPt2 which is the absolute value of the slope of a line connecting a third measurement value and a fourth measurement value respectively measured at a third time point t7 and a fourth time point t8, it is determined that oxidation of oxidizable substances is completed, and thus supply of the pretreatment gas P is stopped.

In the above water quality confirmation step S31 (S3a, S3b, S3c, S3d1), the example in which the control unit 55 calculates the first slope Pt1 and the second slope Pt2 on the basis of at least four measurement values obtained at four time points (e.g., t5, t6, t7, t8), has been shown. However, without limitation thereto, the control unit 55 may calculate the first slope Pt1 and the second slope Pt2 on the basis of at least three measurement values obtained at three time points (e.g., t6, t7, t8). In this case, the slope of a line connecting the first measurement value at the first time point t6 and the second measurement value at the second time point t7 is used as the first slope Pt1, and the slope of a line connecting the second measurement value at the second time point t7 and the third measurement value at the third time point t8 is used as the second slope Pt2, to perform the above determination.

In the above water quality confirmation step S31, whether or not the second slope Pt2 is smaller than the first slope Pt1 (first slope Pt1>second slope Pt2) is determined in the oxidation progress determination step S3d1. However, without limitation to this determination method, for example, whether or not a value obtained by dividing the second slope Pt2 by the first slope Pt1 is equal to or smaller than a predetermined second value R2 ((second slope Pt2/first slope Pt1)≤R2) may be determined. In this case, for example, if a predetermined value smaller than 1 is set as the first value R1, a margin can be provided for the determination, whereby the pretreatment process is prevented from being unintentionally stopped due to error of the measurement value or the like, and thus operation of the pretreatment process can be stabilized.

Thus, the pretreatment process by the control unit 55 in the case of performing the pretreatment gas supply step and the water quality confirmation step at the same time, i.e., in the case of performing water quality measurement for the filtered water Y while always supplying the pretreatment gas P into the filtered water Y, has been described.

Hereinafter, the case of performing the pretreatment gas supply step and the water quality confirmation step alternately, i.e., the case of intermittently supplying the pretreatment gas P to the filtered water Y with a predetermined interruption period provided, and performing water quality measurement for the filtered water Y in the interruption period at the interval in supply of the pretreatment gas P, will be described.

In the above-described case of performing the pretreatment gas supply step and the water quality confirmation step at the same time, the control unit 55 uses a determination method different between the case of measuring at least one of the DO value or the ORP value and the case of measuring the pH value. In the below-described case of performing the pretreatment gas supply step and the water quality confirmation step alternately, the same determination method is used in any of the cases where the measurement value to be acquired is the DO value, the ORP value, or the pH value.

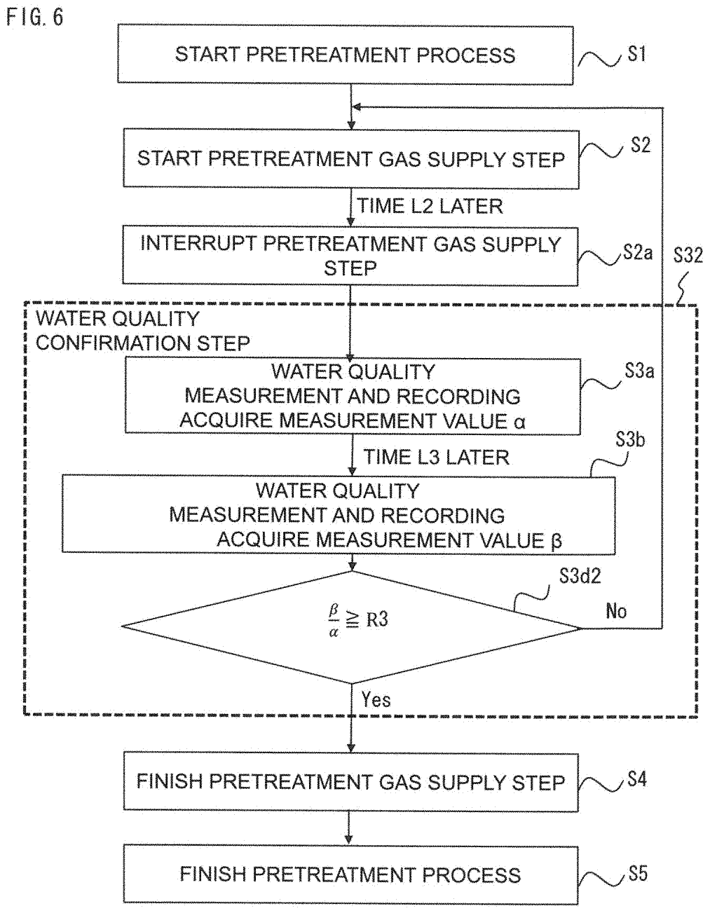

FIG. 6 is a flowchart showing the treatment method in the case where the control unit 55 performs the pretreatment process on the basis of the DO value, the ORP value, or the pH value measured in the interruption period at the interval in supply of the pretreatment gas P, according to embodiment 1.

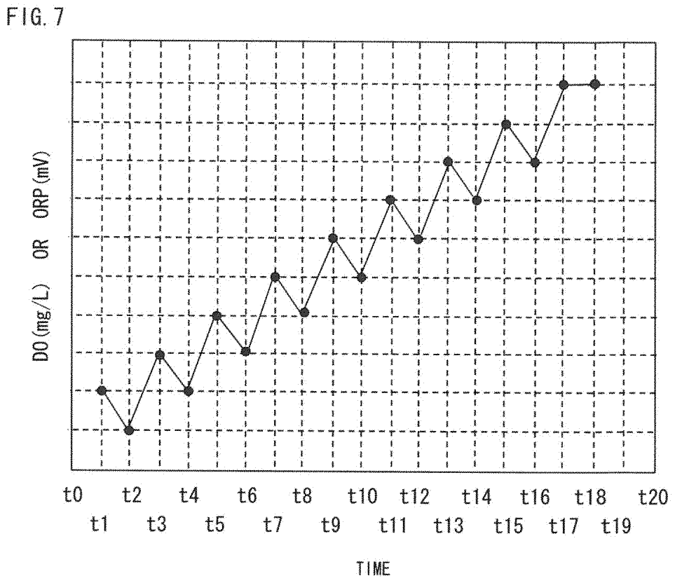

FIG. 7 is a graph showing change over time in the DO value or the ORP value obtained by the water quality measurement device 56 measuring the filtered water Y in the interruption period at the interval in supply of the pretreatment gas P, according to embodiment 1.

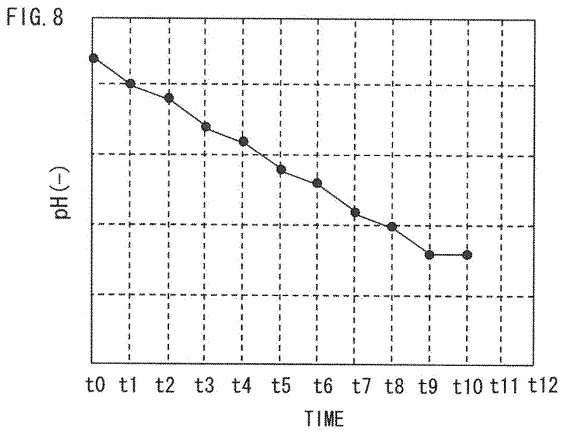

FIG. 8 is a graph showing change over time in the pH value obtained by the water quality measurement device 56 measuring the filtered water Y in the interruption period at the interval in supply of the pretreatment gas P, according to embodiment 1.

When the pretreatment process is started (step S1), first, the control unit 55 starts the pretreatment gas supply step to supply the pretreatment gas P into the filtered water Y (step S2).

Next, when a predetermined supply time L2 has elapsed, the control unit 55 interrupts supply of the pretreatment gas P (step S2a), and in the interruption period during which supply of the pretreatment gas is interrupted, the control unit 55 starts the water quality confirmation step for determining oxidation progress of oxidizable substances in the filtered water Y (step S32). It is noted that L2 is favorably 10 to 600 seconds.

In this water quality confirmation step S32, the control unit 55 performs water quality measurement for at least one of the DO value, the ORP value, or the pH value of the filtered water Y by the water quality measurement device 56, and records the measurement value thereof (step S3a).

Next, the control unit 55 further performs water quality measurement again after elapse of a time L3 therefrom, and records the measurement value thereof (step S3b).

Next, the control unit 55 uses the measurement values obtained in step S3a and step S3b as a first measurement value α and a second measurement value β, respectively, and compares the ratio therebetween, i.e., a value obtained by dividing the second measurement value β by the first measurement value α, with a predetermined third value R3 (step S3d2).

It is noted that L3 is favorably 10 to 600 seconds and the third value R3 is favorably 0.5 to 1.2.

As a result of the comparison, if the measurement value ratio obtained by dividing the second measurement value β by the first measurement value α is equal to or greater than the third value R3 (step S3d2, Yes), the control unit 55 determines that oxidation of oxidizable substances in the filtered water Y is completed, and determines to stop supply of the pretreatment gas P to the filtered water Y. In this case, after completing the water quality confirmation step S32, the control unit 55 completes the pretreatment gas supply step, to stop supply of the pretreatment gas P (step S4), and thus finishes the pretreatment process (step S5).

On the other hand, as a result of the comparison, if the value of second slope β/first slope α is smaller than R3 (step S3d2), the control unit 55 returns to step S2 to restart the pretreatment gas supply step, and performs the water quality confirmation step S32 again in the interruption period of supply of the pretreatment gas P.

Hereinafter, the reason why oxidation progress of oxidizable substances in the filtered water Y can be determined by the processing in the water quality confirmation step S32 shown in FIG. 6, will be described.

In FIG. 7, periods during which the DO value or the ORP value increases (e.g., t0 to t1, t2 to t3, t4 to t5, . . . ) are periods during which the pretreatment gas P is supplied into the filtered water Y. In addition, periods during which the DO value or the ORP value decreases (e.g., t1 to t2, t3 to t4, t5 to t6, . . . ) are interruption periods during which supply of the pretreatment gas P is interrupted.

In FIG. 8, periods (t0 to t1, t2 to t3, t4 to t5, . . . ) are periods during which the pretreatment gas P is supplied into the filtered water Y. In addition, periods (t1 to t2, t3 to t4, t5 to t6, . . . ) are interruption periods during which supply of the pretreatment gas P is interrupted.

In FIG. 7, the increase speed of the DO value or the ORP value during a period in which the pretreatment gas P is supplied is greater than that shown in FIG. 3, but the increase speed of the measurement value varies depending on the condition of supply of the pretreatment gas P, and the like.

As shown in FIG. 7, when supply of the pretreatment gas P is interrupted, during the interruption period, the oxidizing substance in the filtered water Y such as oxygen supplied from the pretreatment gas P is consumed by oxidizable substances, so that the pH value, the DO value, or the ORP value gradually reduces. Therefore, in the case where the oxidizing substance remains in the filtered water and oxidation has not been completed, the second measurement value β after elapse of the predetermined time L2 is sufficiently reduced relative to the first measurement value a acquired immediately after supply of the pretreatment gas is stopped.

On the other hand, when oxidation of oxidizable substances has sufficiently progressed, the reduction width of the second measurement value β relative to the first measurement value a becomes small or the second measurement value β becomes equal to or greater than the first measurement value α. Such a fact has been found through earnest studies.

Therefore, by comparing the ratio between the first measurement value α and the second measurement value β, i.e., the measurement value ratio obtained by dividing the second measurement value β by the first measurement value a with the predetermined third value R3 every time the water quality confirmation step is performed in the interruption period of supply of the pretreatment gas P, it is possible to determine oxidation progress of oxidizable substances and find the oxidation completion point.

As described above, in the interruption period of supply of the pretreatment gas P, in the case where there are characteristics in which the measurement value ratio changes between before and after completion of oxidation of oxidizable substances, it is possible to accurately find the oxidation completion point of oxidizable substances by performing determination using the measurement value ratio as the first change amount of the measurement value.

In the present embodiment, when a magnitude relationship is compared between the third value R3 and the measurement value ratio obtained by dividing the second measurement value β measured at the second time point t18 in FIG. 7 by the first measurement value a measured at the first time point t17, it is determined that oxidation of oxidizable substances is completed, and thus supply of the pretreatment gas P is stopped.

As described above, also in the interruption period of supply of the pretreatment gas P, there are characteristics in which the slope of the measurement value in the interruption period changes between before and after completion of oxidation of oxidizable substances. Therefore, also in the interruption period of supply of the pretreatment gas P, determination may be performed using the slope of the measurement value in the interruption period as the first change amount of the measurement value.

In this case, for example, a magnitude relationship is compared between the first slope ΔPt1 which is the absolute value of the slope of a line connecting a first measurement value and a second measurement value respectively measured at the first time point t15 and the second time point t16 in FIG. 7, and the second slope ΔPt2 which is the absolute value of the slope of a line connecting a third measurement value and a fourth measurement value respectively measured at the third time point t17 and the fourth time point t18.

In the oxidation device and the water treatment method according to the present embodiment configured as described above, the control unit determines oxidation progress of oxidizable substances in the treatment target water on the basis of the first change amount obtained from change over time in the measurement value obtained through water quality measurement for the treatment target water by the water quality measurement device, and determines to continue or stop supply of the pretreatment gas to the treatment target water. Thus, the oxidation completion point of oxidizable substances contained in the treatment target water can be found, and the supply amount of the pretreatment gas to be supplied into the treatment target water can be adjusted in accordance with oxidation progress of oxidizable substances. Therefore, it becomes possible to supply the pretreatment gas without excess/deficiency even in the case where the water quality of the treatment target water is not stable. Thus, it is possible to obtain treatment target water in which dissolution of carbonate ions due to excess supply of the pretreatment gas is reduced and oxidizable substances are sufficiently removed.

The water treatment device configured as described above includes the filtration unit for filtering organic substances in raw water to generate filtered water, the first transfer unit for transferring the filtered water to the treatment water tank, the ozone water generation unit for supplying ozone gas to the filtered water for which supply of the pretreatment gas has been determined to be stopped, to generate ozone water, and the second transfer unit for transferring the ozone water to the filtration unit. Thus, the filtration membrane for filtering organic substances can be cleaned using ozone water having a high cleaning effect, which is generated on the basis of filtered water in which dissolution of carbonate ions is reduced and oxidizable substances are sufficiently removed. Thus, clogging of the filtration membrane and the like are effectively prevented and the water treatment device can be stably operated.

In addition, since the ozone water is generated using the filtered water, the cost can be reduced as compared to the case of generating ozone water using tap water or the like.

In the ozone water generation method configured as described above, ozone water is generated by supplying ozone gas to the treatment target water for which supply of the pretreatment gas has been determined to be stopped. Thus, ozone water is generated on the basis of the treatment target water in which dissolution of carbonate ions is reduced and oxidizable substances are sufficiently removed. Therefore, ineffective consumption of ozone by oxidizable substances can be minimized and ozone water having a high cleaning effect can be obtained.

In the cleaning method configured as described above, the filtration membrane can be cleaned using the ozone water generated as described above. Since the filtration membrane is cleaned using the ozone water having a high cleaning effect as described above, a high sterilizing effect, a high deodorizing effect, and the like for the filtration membrane are obtained.

It is noted that a cleaning target part to be cleaned using the ozone water generated as described above is not limited to such a filtration membrane used for water cleaning treatment, waste water treatment, or the like. For example, the cleaning target part may be food, a medical apparatus, or the like, and a high cleaning effect can be similarly obtained also for such cleaning target parts.

The control unit uses the slope of the measurement value as the first change amount obtained from change over time in the measurement value obtained through water quality measurement for the filtered water.

Therefore, in the case where the measurement target has characteristics in which the slope of the measurement value changes before and after completion of oxidation of oxidizable substances, it is possible to accurately find the oxidation completion point of oxidizable substances by performing determination using the above slope of the measurement value as the first change amount of the measurement value.

The control unit uses the relationship between the first slope of a line connecting a first measurement value and a second measurement value and the second slope of a line connecting a third measurement value and a fourth measurement value, as the first change amount. By thus performing determination using the relationship between two slopes that change over time, the oxidation completion point of oxidizable substances can be found more accurately.

The control unit may use the relationship between the first slope of a line connecting a first measurement value and a second measurement value and the second slope of a line connecting a second measurement value and a third measurement value, as the first change amount. In this case, measurement for a fourth measurement value is not needed, and thus the oxidation completion point for oxidizable substances can be found quickly.

In the configuration in which the pretreatment gas is continuously supplied to the filtered water, in the case of measuring the DO value or the ORP value of filtered water, the control unit determines to stop supply of the pretreatment gas to the filtered water when the absolute value of the second slope becomes greater than the absolute value of the first slope. In the case of using, as a measurement target, the DO value or the ORP value of which the increase speed becomes great when oxidation of oxidizable substances in the filtered water is completed, it is possible to accurately find the oxidation completion point of oxidizable substances by detecting the time point at which the second slope becomes great as described above.

When a value obtained by dividing the second slope by the first slope becomes equal to or greater than the predetermined first value, the control unit may determine to stop supply of the pretreatment gas to the filtered water. In this case, the pretreatment process is prevented from being unintentionally stopped due to error of the measurement value or the like, and thus operation of the pretreatment process can be stabilized.

In the configuration in which the first substances are continuously supplied to the treatment target water, in the case of measuring the pH value of the filtered water, the control unit determines to stop supply of the pretreatment gas to the filtered water when the second slope becomes smaller than the first slope. In the case of using, as a measurement target, the pH value for which the reduction speed of the measurement value becomes small when oxidation of oxidizable substances in the filtered water is completed, it is possible to accurately find the oxidation completion point of oxidizable substances by detecting the time point at which the second slope becomes small as described above.

When a value obtained by dividing the second slope by the first slope becomes equal to or smaller than the predetermined second value, the control unit may determine to stop supply of the pretreatment gas to the filtered water. In this case, the pretreatment process is prevented from being unintentionally stopped due to error of the measurement value or the like, and thus operation of the pretreatment process can be stabilized.

In the configuration in which the pretreatment gas is intermittently supplied to the filtered water with a predetermined interruption period provided, the control unit uses the ratio of two measurement values immediately after the interruption period and after elapse of a predetermined time, as the first change amount obtained from change over time in the measurement value obtained through water quality measurement for the filtered water.

Therefore, in the interruption period of the pretreatment gas, in the case where the measurement target has characteristics in which the ratio of the two measurement values respectively measured changes between before and after completion of oxidation of oxidizable substances, it is possible to accurately find the oxidation completion point of oxidizable substances by performing determination using the ratio of the two measurement values as the first change amount of the measurement value.

In the interruption period, when the measurement value ratio obtained by dividing the second measurement value by the first measurement value becomes equal to or greater than the predetermined third value, the control unit determines to stop supply of the pretreatment gas to the filtered water.

In the case of using the DO value, the ORP value, or the ph value as the measurement target, when oxidation of oxidizable substances in the filtered water is completed, in the interruption period, the measurement value ratio obtained by dividing the second measurement value by the first measurement value becomes small. Therefore, it is possible to more accurately find the oxidation completion point of oxidizable substances by performing such determination as described above.

The control unit performs supply of the oxidizing substance to the filtered water by jetting the pretreatment gas which is gas containing the oxidizing substance as an oxidation material into the filtered water. Thus, handling is easy as compared to the case of using a liquid or the like containing an oxidizing substance.

In the above description, the case where the control unit 55 uses the amount of change over time in the pH value, the dissolved oxygen concentration (DO) value, or the standard oxidation reduction potential (ORP) value, as the first change amount of the measurement value, has been shown, but the first change amount of the measurement value is not limited thereto. As the first change amount of the measurement value, a water quality other than the pH value, the DO value, and the ORP value may be measured as long as characteristics in which the measurement value changes over time between before and after completion of oxidation of oxidizable substances in the filtered water Y are obtained.

In the above description, the case where the oxidation unit 54 includes the treatment water tank 51, the pretreatment gas supply device 52, and the pretreatment gas supply pipe 53, has been shown. However, without limitation to this configuration, the oxidation unit 54 may have any configuration that can supply an oxidation material to the filtered water Y and oxidize oxidizable substances contained in the filtered water.

In the above description, the case where the ozone water generation unit 60 includes only the ozone generator 61 and the ozone gas supply pipe 62, has been shown. However, without limitation to this configuration, the ozone water generation unit 60 may include an ozone water generation tank dedicated for generating ozone water O, for example.

In addition, the ozone water generation unit 60 may be provided in the oxidation device 50.

In the case of using the slope of the measurement value as the first change amount, the control unit is not limited to a configuration of calculating the absolute value ΔP of the slope of a line connecting the measurement value α and the measurement value β as shown in the above Expression (1). The control unit may use the slope that is not an absolute value, of a line connecting the measurement value α and the measurement value β, to detect change over time in the slope of the measurement value, and determine oxidation progress.

The oxidation material containing an oxidizing substance, to be supplied into the filtered water, is not limited to gas such as the pretreatment gas P, but may be liquid oxygen, for example.

In the above description, the oxidation device 50 performs the pretreatment process for removing oxidizable substances, for the filtered water Y filtered by the filtration unit 1. However, the oxidation device is not limited thereto.

For example, the oxidation device may be configured to remove oxidizable substances in the raw water X stored in the filtration water tank 3 of the filtration unit 1. In this case, the water quality measurement device 56 and the pretreatment gas supply device 52 may be provided to the filtration water tank 3. Then, the control unit 55 determines oxidation progress of oxidizable substances in the raw water X on the basis of the first change amount obtained through water quality measurement for the raw water X as treatment target water obtained by the water quality measurement device 56, and thereby determines to continue or stop supply of the pretreatment gas P to the raw water X. In this case, the ozone water generation unit 60 directly supplies ozone gas to the raw water X in the filtration water tank 3, thereby decomposing impurities such as organic substances contained in the raw water X.

### Embodiment 2

Hereinafter, the present embodiment 2 will be described, focusing on differences from the above embodiment 1, with reference to the drawings. The same parts as those in the above embodiment 1 are denoted by the same reference characters, and description thereof is omitted.

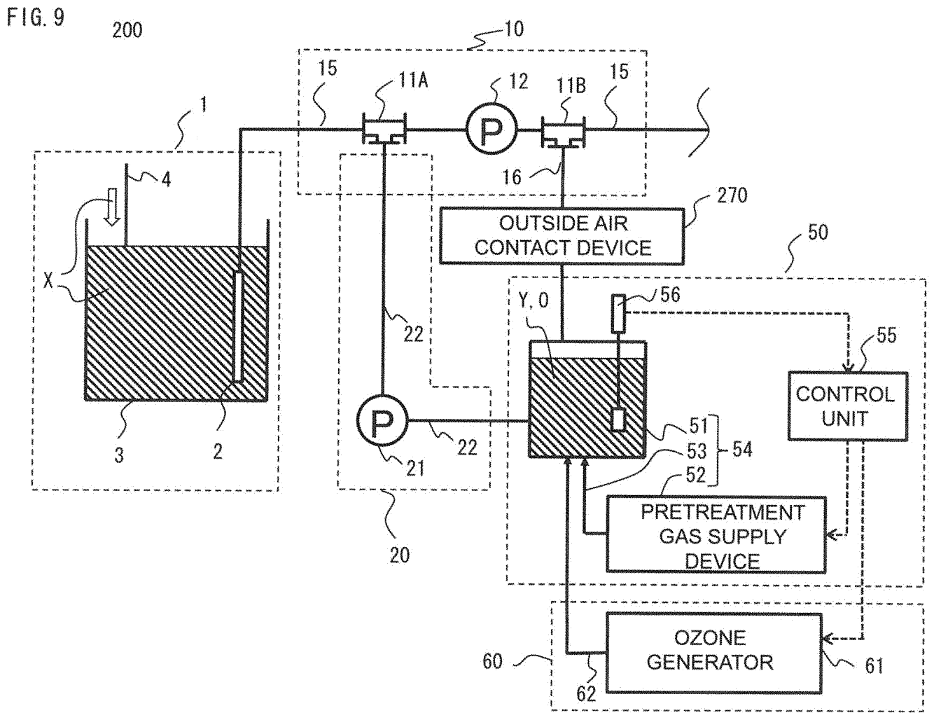

FIG. 9 is a diagram showing the schematic configuration of a water treatment device 200 according to embodiment 2.

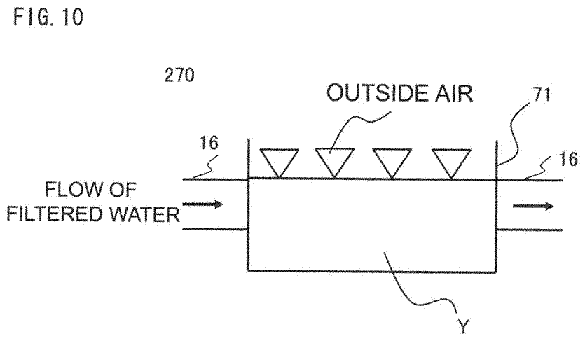

FIG. 10 is a diagram showing an example of the schematic configuration of an outside air contact device 270 according to embodiment 2.

The water treatment device 200 shown in FIG. 9 is the same as the water treatment device 100 shown in FIG. 1 except that the outside air contact device 270 is provided to the cleaning water pipe 16.

When the filtered water Y is transferred to the treatment water tank 51 via the cleaning water pipe 16, the outside air contact device 270 causes the filtered water Y and outside air to be in contact with each other, thereby oxidizing a part of oxidizable substances in the filtered water Y. This makes it possible to shorten the execution period of the pretreatment process and reduce the usage amount of the pretreatment gas P in the oxidation device 50.

As shown in FIG. 10, as the outside air contact device 270, a water tank 71 that opens to the outside air (atmosphere) is used. In the outside air contact device 270, for example, an ejector can also be used, and the outside air is sucked by a negative pressure caused when the filtered water Y flows down through the ejector, whereby the filtered water Y can be mixed with the outside air. In this case, it is possible to oxidize oxidizable substances by the filtered water Y contacting with the outside air when the filtered water Y flows down through the water tank.

The oxidation device and the water treatment method according to the present embodiment configured as described above provide the same effects as in embodiment 1 and can obtain filtered water in which dissolution of carbonate ions in the filtered water is reduced and oxidizable substances are sufficiently removed.

Further, since the outside air contact device for assisting the pretreatment process in the oxidation device is provided, it becomes possible to shorten the execution period of the pretreatment process and reduce the usage amount of the pretreatment gas in the pretreatment process. Thus, the oxidation device and the water treatment device that require low cost and have a high treatment speed can be provided.

### Embodiment 3

Hereinafter, the present embodiment 3 will be described, focusing on differences from the above embodiments 1 and 2, with reference to the drawings. The same parts as those in the above embodiments 1 and 2 are denoted by the same reference characters, and description thereof is omitted.

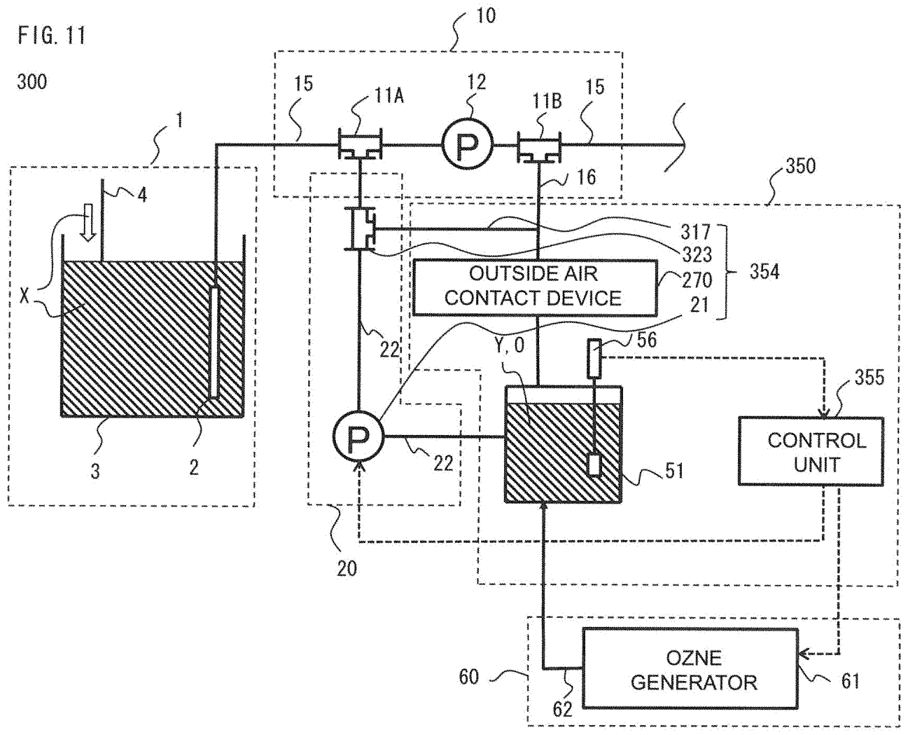

FIG. 11 is a diagram showing the schematic configuration of a water treatment device 300 including an oxidation device 350 according to embodiment 3.

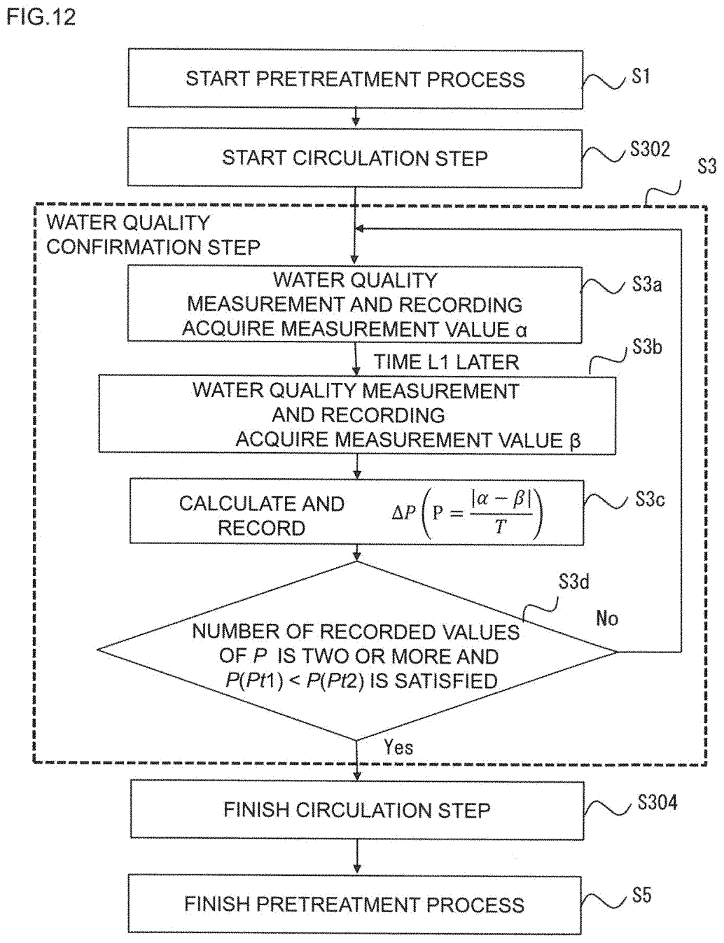

FIG. 12 is a flowchart showing the treatment method in the case where a control unit 355 performs the pretreatment process on the basis of at least one of the DO value or the ORP value measured while a circulation process is being performed, according to embodiment 3.

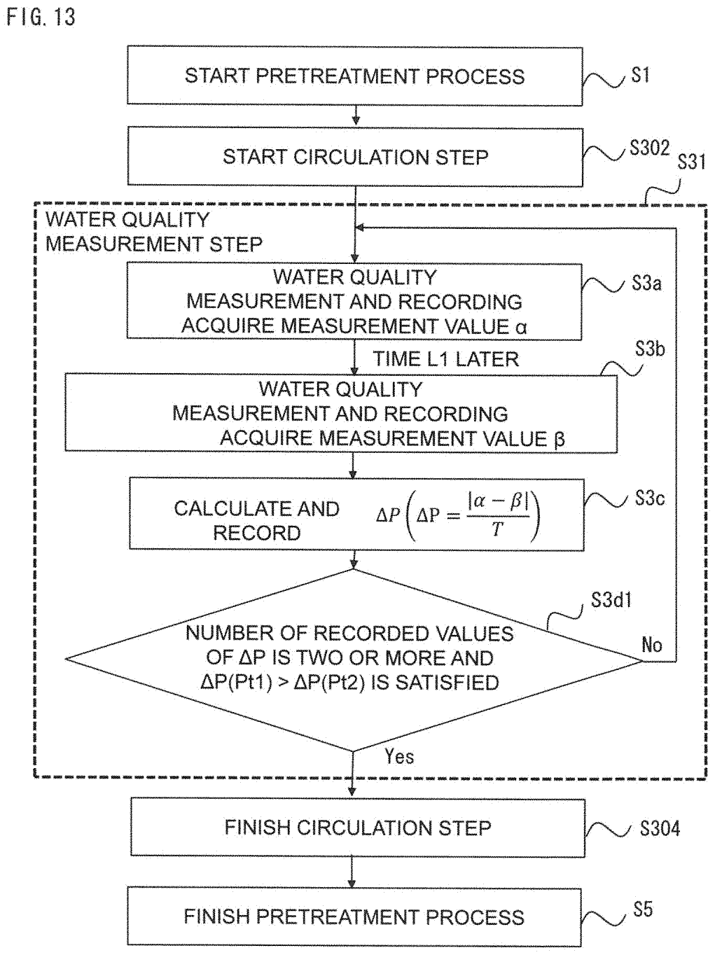

FIG. 13 is a flowchart showing the treatment method in the case where the control unit 355 performs the pretreatment process on the basis of the pH value measured while the circulation process is being performed, according to embodiment 3.

The oxidation device 350 shown in FIG. 11 is configured such that the pretreatment gas supply device 52 and the pretreatment gas supply pipe 53 are removed from the oxidation unit 54 of the oxidation device 50 shown in FIG. 9 in embodiment 2, a switch valve 323 is provided to the cleaning water pipe 22, and the cleaning water pipe 16 and the switch valve 323 are connected via a circulation pipe 317 at a stage preceding the outside air contact device 270.

In the oxidation device 350 according to the present embodiment, an oxidation unit 354 for causing an oxidation material containing an oxidizing substance to be in contact with the filtered water Y includes the outside air contact device 270, the switch valve 323, the circulation pipe 317, and the transfer pump 21. In addition, the control unit 355 receives a water quality measurement result obtained by the water quality measurement device 56, performs calculation described later on the basis of this result, and performs drive control for the transfer pump 21.

In the case of this oxidation device 350, the pretreatment process can be executed as shown in the flowcharts in FIG. 12 and FIG. 13. FIG. 12 and FIG. 13 are different from FIG. 2 and FIG. 4 in that the pretreatment gas supply step S2 is replaced with a circulation step S302.

In the circulation step S302 shown in FIG. 12 and FIG. 13, the control unit 355 drives the transfer pump 21 to suck the filtered water Y stored in the treatment water tank 51 so as to return the filtered water Y to the primary side of the outside air contact device 270 via the switch valve 323 and the circulation pipe 317. Then, the filtered water Y is passed through the outside air contact device 270 to the secondary side, so as to circulate into the treatment water tank 51.

During execution of the circulation step S302, the transfer pump 21 is always driven to repeatedly circulate the filtered water Y. That is, in the present embodiment, the filtered water Y is transferred so that, instead of the pretreatment gas P, the outside air supplied from the outside air contact device 270 is repeatedly brought into contact with the filtered water Y, and the filtered water Y is exposed to the outside air as an oxidation material, whereby oxidizable substances contained in the filtered water Y are oxidized. If the control unit 355 determines that oxidation of oxidizable substances in the filtered water Y is completed, the control unit 355 determines to stop circulation of the filtered water Y to the outside air contact device 270, and stops transfer of the filtered water Y to the outside air contact device 270 (step S304). On the other hand, if the control unit 355 determines that oxidation of oxidizable substances in the filtered water Y is not completed, the control unit 355 determines to continue circulation of the filtered water Y to the outside air contact device 270, and continues to transfer the filtered water Y to the outside air contact device 270.

The water quality confirmation step S3 can be performed in the same manner as the water quality confirmation step S3 described in embodiment 1. In the case of using a DO meter or an ORP meter as the water quality measurement device 56, the pretreatment process can be performed in accordance with the flowchart in FIG. 12. In the case of using a pH meter as the water quality measurement device 56, the flowchart in FIG. 13 can be employed. In addition, as in embodiment 1, it is also possible to perform the circulation step and the water quality confirmation step alternately. In this case, the process may be performed such that start, interruption, and finish of the pretreatment gas supply step shown in FIG. 6 are replaced with start, interruption, and finish of the circulation step.

The oxidation device and the water treatment method according to the present embodiment configured as described above provide the same effects as in embodiment 1, and the control unit determines oxidation progress of oxidizable substances in the filtered water on the basis of the first change amount obtained from change over time in the measurement value obtained through water quality measurement for the filtered water by the water quality measurement device, and determines to continue or stop transfer of the filtered water to the outside air contact device. Thus, the circulation amount of the filtered water to be circulated to the outside air contact device can be adjusted in accordance with oxidation progress of oxidizable substances. Thus, it is possible to obtain filtered water in which dissolution of carbonate ions in the filtered water is reduced and oxidizable substances are sufficiently removed.

Further, the outside air contact device is provided as the oxidation unit for causing the oxidation material containing an oxidizing substance to be in contact with the filtered water Y, and the transfer pump is driven to circulate the filtered water to the outside air contact device so that the filtered water is exposed to the outside air. Thus, it becomes possible to supply an oxidation material without excess/deficiency, to the filtered water Y, with a simple device configuration as in the outside air contact device. Thus, the oxidation device and the water treatment device can be provided at low cost.

### Embodiment 4

Hereinafter, the present embodiment 4 will be described, focusing on differences from the above embodiment 1, with reference to the drawings. The same parts as those in the above embodiment 1 are denoted by the same reference characters, and description thereof is omitted.

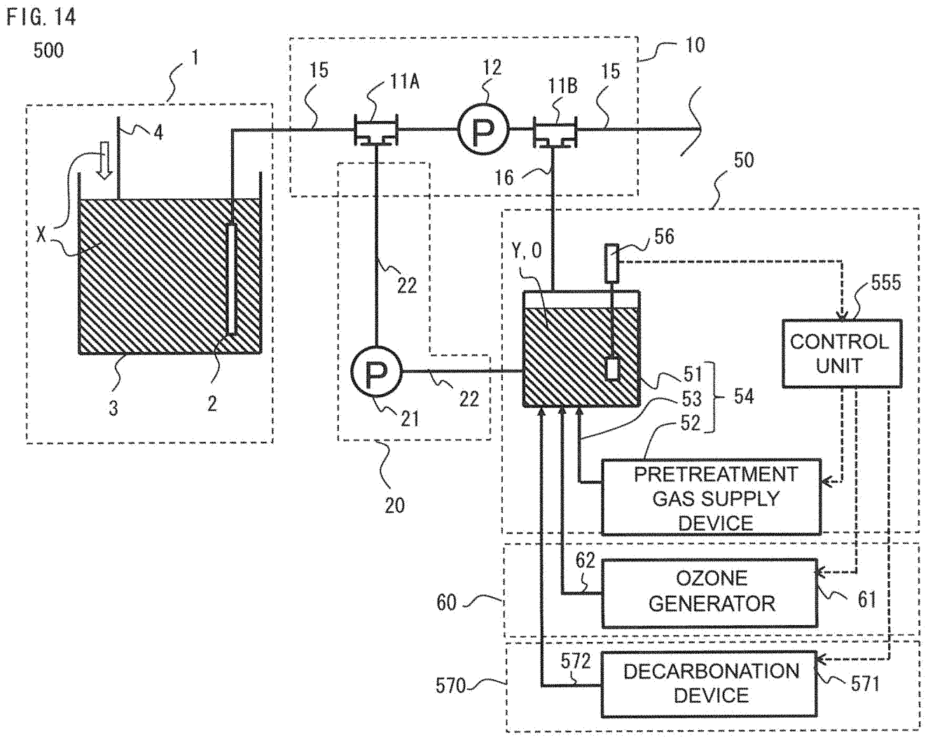

FIG. 14 is a diagram showing the schematic configuration of a water treatment device 500 according to embodiment 4.

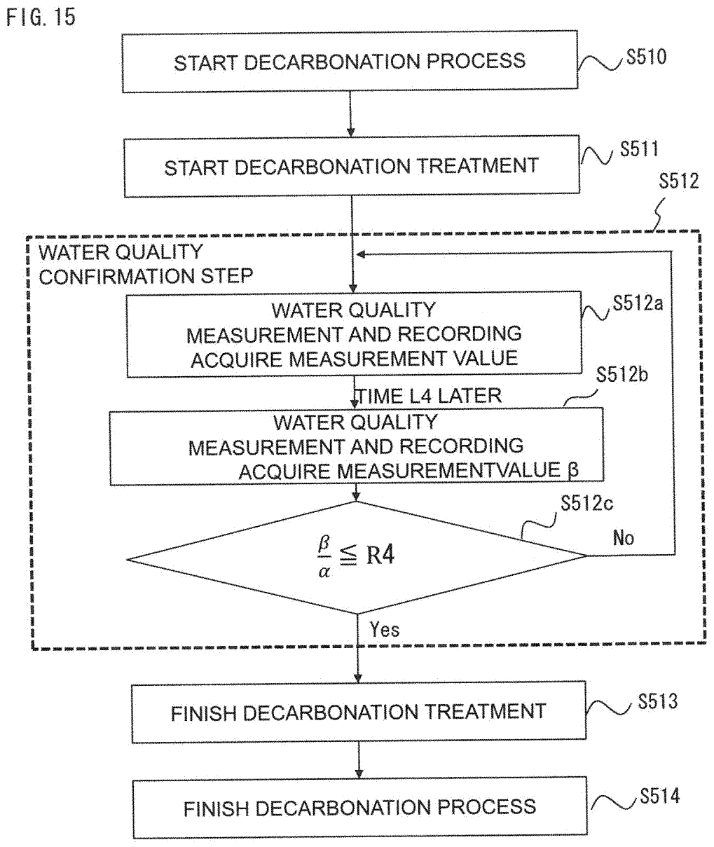

FIG. 15 is a flowchart showing the treatment method for a control unit 555 to remove carbonate ions in the filtered water Y, according to embodiment 4.

In the present embodiment, the control unit 555 performs a decarbonation process for removing carbonate ions in the filtered water Y after the pretreatment process is finished, before the ozone water generation process is started. The process by the control unit 555 is the same as that shown in embodiment 1 except that the decarbonation process is performed.

As shown in FIG. 14, the water treatment device 500 is obtained by adding a decarbonation unit 570 to the water treatment device 100 shown in FIG. 1.

Here, the reason why the decarbonation process for removing carbonate ions is performed for the filtered water Y for which the pretreatment process has been completed, will be described.

In the case where the concentration of oxidizable substances contained in the filtered water is high, it takes time to oxidize the oxidizable substances, so that the period for performing the pretreatment process is comparatively long, and the supply amount of the pretreatment gas or the amount of outside air supplied by the outside air contact device also increases. Therefore, in particular, in the case of using air as the pretreatment gas and in the case of performing oxidation using outside air by the outside air contact device, the amount of dissolution of carbon dioxide gas contained in the air and the outside air into the filtered water also increases.

Carbonate ions in water act as a radical scavenger and consume OH radicals which are generated through self-decomposition of ozone and have a high capability of decomposing organic substances. Therefore, presence of carbonate ions in high concentration might not be preferable in terms of keeping the cleaning effect of ozone water at high level.

Through earnest studies, it has been found that, by executing the “decarbonation process” for removing carbonate ions in the filtered water by a predetermined method after the pretreatment process is completed, it is possible to keep the cleaning effect of ozone water at high level irrespective of the method and the time period for performing the pretreatment process. In addition, it has been found that, in removal of carbonate ions, it is possible to clearly recognize completion of removal of carbonate ions by monitoring a certain water quality while performing operation for removing carbonate ions.

Hereinafter, the details of the decarbonation process will be described. The decarbonation process can be executed in accordance with the flowchart shown in FIG. 15.

After the pretreatment process is completed, the control unit 555 starts the decarbonation process (step S510), and thus starts a decarbonation treatment (step S511).

Here, in the decarbonation treatment, the decarbonation unit 570 is driven to perform a decarbonation operation for removing carbonate ions from the filtered water. The decarbonation unit 570 may be formed from one or a plurality of devices selected from a “decarbonation gas supply device” for supplying the filtered water Y with decarbonation gas having a carbon dioxide gas content volume ratio of 100 ppm or smaller, such as oxygen gas, nitrogen gas, or mixture gas of oxygen and nitrogen, a “heating device” capable of heating the filtered water Y, an “ultrasonic oscillation device” capable of applying ultrasonic waves to the filtered water Y, and the like. Therefore, in the decarbonation treatment, for example, in the case of using the decarbonation gas supply device as the decarbonation unit 570, decarbonation gas is supplied through a decarbonation gas supply pipe 572 to the filtered water Y stored in the treatment water tank 51, in the case of using the heating device, heating is started, and in the case of using the ultrasonic oscillation device, application of ultrasonic waves is started.

Next, the control unit 555 starts a water quality confirmation step for determining removal progress of carbonate ions in the filtered water Y being subjected to the decarbonation treatment (step S512).

In the water quality confirmation step, the control unit 555 performs water quality measurement for the filtered water Y by the water quality measurement device 56, and records the water quality measurement result as an intermediate treatment measurement value (step S512a). The water quality to be measured is favorably pH.

Next, after elapse of time L4, the control unit 555 performs water quality measurement again and records the water quality measurement result as an intermediate treatment measurement value again (step S512b).

Next, using the intermediate treatment measurement values obtained in step S512a and step S512b as a first intermediate treatment measurement value α and a second intermediate treatment measurement value β, respectively, the control unit 555 compares a second change amount obtained from change over time in the intermediate treatment measurement value, i.e., a value obtained by dividing the second intermediate treatment measurement value β by the first intermediate treatment measurement value a, with a predetermined fourth value R4 (step S512c).

As a result of the comparison, if the value obtained by dividing the second intermediate treatment measurement value β by the first intermediate treatment measurement value α is equal to or smaller than the fourth value R4 (step S512c, Yes), the control unit 555 determines that removal of carbonate ions in the filtered water Y is completed, and determines to stop the decarbonation treatment for the filtered water Y. In this case, after the water quality confirmation step is completed, the control unit 55 completes the decarbonation treatment and stops the decarbonation treatment (step S513), and then finishes the decarbonation process (step S514).

On the other hand, as a result of the comparison, if the value obtained by dividing the second intermediate treatment measurement value β by the first intermediate treatment measurement value α is greater than the fourth value R4 (step S512c, No), the control unit 555 returns to step S512a to continue the water quality confirmation step.

It is noted that the fourth value R4 is favorably 1.0 to 1.5.

After the decarbonation process is completed, the control unit 555 performs the ozone water generation process and the cleaning process as in embodiment 1.

Hereinafter, the reason why removal progress of carbonate ions in the filtered water Y can be determined through the processing in the water quality confirmation step S512 shown in FIG. 15, will be described.

Although not shown, in the case of performing decarbonation for the filtered water by supply of decarbonation gas, heating, or ultrasonic waves, carbonate ions in the liquid phase are released as gas to the gas phase, so that the pH of the filtered water increases. However, when carbonate ions are sufficiently released from the filtered water, change in each water quality becomes gradual. Therefore, it is possible to clearly confirm the decarbonation completion point by monitoring the pH value as described above.

In the above description, the “decarbonation gas supply device”, the “heating device”, and the “ultrasonic oscillation device” have been shown as the decarbonation unit 570, but another device may be used.

As the decarbonation unit 570, a pH adjustment device for adding an acidic chemical as a pH adjustment agent to the filtered water Y so that the filtered water Y has a desired pH value, may be used.

The state of carbonate ions changes depending on the pH, and generally in an acidic region, most part thereof is released as carbon dioxide gas to the gas phase. Using this property, it is possible to remove carbonate ions from the filtered water by adding an acidic chemical such as hydrochloric acid or sulfuric acid to the filtered water Y so as to adjust the pH to an acidic state. In this case, the water quality confirmation step does not necessarily need to be performed as shown in the water quality confirmation step S512 in FIG. 15, and the control unit 555 may control a decarbonation device 571 (pH adjustment device) so that the pH value obtained by the water quality measurement device 56 becomes a predetermined target pH value, to add an acidic chemical to the filtered water Y.

The target pH value is favorably 4 to 6.5. If the target pH value is excessively low, an acidic chemical is added even when carbonate ions are no longer present, and this is inefficient. In addition, in the subsequent cleaning process, self-decomposition of ozone is significantly inhibited and thus there is a possibility that generation of OH radicals is hampered, leading to reduction in the cleaning effect. On the other hand, if the target pH value is high, the carbonate ions cannot be sufficiently turned into carbon dioxide gas, and thus the decarbonation effect cannot be obtained.

It is noted that whether or not to perform the decarbonation process for the filtered water Y after the pretreatment process is completed may be determined at each time by, for example, measuring M alkalinity or directly measuring the sodium bicarbonate ion concentration by ion chromatography, and estimating the carbonate ion concentration. Alternatively, the decarbonation process may be performed in the case of exceeding a reference value optionally set, within a range in which the cumulative period of supply of the pretreatment gas in the pretreatment process or the cumulative period of execution of the circulation step does not exceed 60 minutes.

In the oxidation device and the water treatment method according to the present embodiment configured as described above, the control unit determines removal progress of carbonate ions in the filtered water on the basis of the second change amount obtained from change over time in the measurement value obtained through water quality measurement for the filtered water by the water quality measurement device, and determines to continue or stop removal of carbonate ions from the filtered water. Thus, it is possible to find the removal completion point of carbonate ions contained in the filtered water, and adjust the operation quantity of decarbonation operation to be performed for the filtered water in accordance with removal progress. Therefore, filtered water from which carbonate ions are sufficiently removed can be obtained irrespective of the execution period of the pretreatment process or the supply amount of the oxidation material.

In the ozone water generation method configured as described above, ozone gas is supplied to the filtered water for which the decarbonation process has been determined to be stopped, thereby generating ozone water. Thus, since ozone water can be generated on the basis of the filtered water from which carbonate ions are removed, ozone water having a higher cleaning effect can be obtained.

In the cleaning method configured as described above, a cleaning target part can be cleaned using the ozone water generated as described above. Thus, since a cleaning target part is cleaned using ozone water having a higher cleaning effect, the effect of removing dirt in the cleaning target part can be further improved.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1 filtration unit

2 filtration membrane (cleaning target part)

10 first transfer unit

20 second transfer unit

50, 350 oxidation device

54 oxidation unit

55, 355, 555 control unit

56 water quality measurement device (measurement unit)

570 decarbonation unit

60 ozone water generation unit

270 outside air contact device

100, 200, 300, 500 water treatment device

1.-20. (canceled)

21. An ozone water generation device for generating ozone water using treatment target water, the ozone water generation device comprising:
an oxidationor for supplying an oxidation material to the treatment target water so as to make contact therebetween, to generate contacted treatment target water;
a measurer for performing water quality measurement for the contacted treatment target water;
a controller for performing control to continue or stop supply of the oxidation material to the generated contacted treatment target water on the basis of a first change amount obtained from change over time in a measurement value obtained through the water quality measurement by the measurer, to generate controlled treatment target water; and
an ozone water generator for supplying ozone to the controlled treatment target water, to generate the ozone water.

22. The ozone water generation device according to claim 21, wherein the controller determines whether oxidation of oxidizable substances in the contacted treatment target water is completed, on the basis of the first change amount, and performs control to continue or stop supply of the oxidation material to the contacted treatment target water on the basis of a result of the determination, to generate the controlled treatment target water.

23. A water treatment device comprising:
the ozone water generation device according to claim 21;
a filter for filtering organic substances in raw water to generate filtered water;
a first transferor for transferring the filtered water as the treatment target water to the oxidationor; and
a second transferor for transferring the ozone water to the filter.

24. The water treatment device according to claim 23, wherein
the first transferor includes a first outside air contact device for exposing the filtered water to outside air.

25. An ozone water generation method for generating ozone water using treatment target water, the ozone water generation method comprising:
an oxidation step of supplying an oxidation material to the treatment target water so as to make contact therebetween, to generate contacted treatment target water;
a water quality measurement step of performing water quality measurement for the contacted treatment target water;
a controlled treatment target water generation step of performing control to continue or stop supply of the oxidation material to the generated contacted treatment target water on the basis of a first change amount obtained from change over time in a measurement value obtained through the water quality measurement in the water quality measurement step, to generate controlled treatment target water; and
an ozone water generation step of supplying ozone to the controlled treatment target water, to generate the ozone water.

26. The ozone water generation method according to claim 25, wherein
in the controlled treatment target water generation step,
whether oxidation of oxidizable substances in the contacted treatment target water is completed is determined on the basis of the first change amount, and control to continue or stop supply of the oxidation material to the contacted treatment target water is performed on the basis of a result of the determination, to generate the controlled treatment target water.

27. The ozone water generation method according to claim 25, wherein
a slope of the measurement value is used as the first change amount.

28. The ozone water generation method according to claim 25, wherein
a ratio of the measurement value is used as the first change amount.

29. The ozone water generation method according to claim 27, wherein
the measurement value measured at a first time point is defined as a first measurement value, and the measurement value measured at a second time point after the first time point is defined as a second measurement value,
the measurement value measured at a third time point after the second time point is defined as a third measurement value, and the measurement value measured at a fourth time point after the third time point is defined as a fourth measurement value, and
a relationship between a first slope of a line connecting the first measurement value and the second measurement value, and a second slope of a line connecting the third measurement value and the fourth measurement value or a line connecting the second measurement value and the third measurement value, is used.

30. The ozone water generation method according to claim 29, wherein
the measurement value is at least one of a dissolved oxygen concentration value or a standard oxidation reduction potential value of the contacted treatment target water, and the oxidation material is continuously supplied to the treatment target water, and
control to stop supply of the oxidation material to the contacted treatment target water is performed, when an absolute value of the second slope becomes greater than an absolute value of the first slope or a value obtained by dividing the absolute value of the second slope by the absolute value of the first slope becomes equal to or greater than a predetermined first value.

31. The ozone water generation method according to claim 29, wherein
the measurement value is a pH value of the contacted treatment target water, and the oxidation material is continuously supplied to the treatment target water, and
control to stop supply of the oxidation material to the contacted treatment target water is performed, when an absolute value of the second slope becomes smaller than an absolute value of the first slope or a value obtained by dividing the absolute value of the second slope by the absolute value of the first slope becomes equal to or smaller than a predetermined second value.

32. The ozone water generation method according to claim 28, wherein
the oxidation material is intermittently supplied to the treatment target water with a predetermined interruption period provided,
the ratio of the measurement value in the interruption period is used as the first change amount,
the measurement value measured at a first time point is defined as a first measurement value, and the measurement value measured at a second time point after the first time point is defined as a second measurement value, and
control to stop supply of the oxidation material to the contacted treatment target water is performed, when the ratio of the measurement value obtained by dividing the second measurement value by the first measurement value becomes equal to or greater than a predetermined third value.

33. The ozone water generation method according to claim 25, wherein
the measurement value is at least one of a dissolved oxygen concentration value, a standard oxidation reduction potential value, or a pH value of the contacted treatment target water.

34. The ozone water generation method according to claim 25, wherein
supply of the oxidation material to the treatment target water is performed by jetting gas as the oxidation material, into the treatment target water.

35. The ozone water generation method according to claim 25, wherein
supply of the oxidation material to the treatment target water is performed by transferring the treatment target water so that the treatment target water is exposed to outside air as the oxidation material.

36. The ozone water generation method according to claim 25, wherein
removal of carbonate ions in the controlled treatment target water is performed.

37. The ozone water generation method according to claim 36, wherein
removal progress of the carbonate ions in the controlled treatment target water is determined on the basis of a second change amount obtained from change over time in an intermediate treatment measurement value obtained through water quality measurement for the controlled treatment target water for which the removal of the carbonate ions has been performed, and thus control to continue or stop the removal of the carbonate ions in the controlled treatment target water is performed.

38. The ozone water generation method according to claim 37, wherein
the intermediate treatment measurement value is a pH value of the treatment target water, and
a ratio of the intermediate treatment measurement value is used as the second change amount.

39. The ozone water generation method according to claim 36, wherein
the removal of the carbonate ions in the controlled treatment target water is performed using at least one of jetting of decarbonation gas into the controlled treatment target water, heating of the controlled treatment target water, or application of ultrasonic vibration to the controlled treatment target water.

40. The ozone water generation method according to claim 36, wherein
the removal of the carbonate ions in the controlled treatment target water is performed by adding a pH adjustment agent made of an acidic chemical to the controlled treatment target water so that the controlled treatment target water has a predetermined pH value.

41. A cleaning method comprising cleaning a cleaning target part using the ozone water generated by the ozone water generation method according to claim 25.
